(19) United States
(12) Patent Application Publication
(10) Pub. No.: US 2003/0114101 A1
(43) Pub. Date: Jun. 19, 2003

(54) Companion sealing and ventilation window modules

(75) Inventor: Haggai Paz, Zoran (IL)

Correspondence Address: BROWDY AND NEIMARK, P.L.L.C., 624 NINTH STREET, NW, SUITE 300, WASHINGTON, DC, 20001-5303, US

(73) Assignee: Keter Plastic Ltd., Herzelyia (IL)

(21) Appl. No.: 10/013,844

(22) Filed: Dec. 13, 2001

(51) Int. Cl. E06B 7/08

(52) U.S. Cl. 454/224

(57) ABSTRACT

A companion set of sealing and ventilation injection-molded window modules each being installable in a port on the side of a shed to admit natural light into the shed. The choice of module depends on the shed's mode of use. When in a storage mode to store goods, then the sealing module installed in the port is adapted to exclude both air and rain. When in a shelter mode to accommodate individuals, then the ventilation module installed in the port is adapted to admit air and exclude rain.

### BACKGROUND OF THE INVENTION

1. Field of the Invention

This invention relates generally to windows for sheds, and in particular to a companion set of sealing and ventilation window modules installable in a port at the side of a shed to admit natural light into the shed. The sealing module, when installed, is adapted to exclude both air and rain whereas the ventilation module, when installed, is adapted to admit air but exclude rain.

2. Status of Prior Art

A shed is a small structure usable for shelter or for storage. Regardless of its mode of use, a shed requires natural light, for it is often erected at a site where electric power for lighting is not available or where it is undesirable to electrically wire the shed. But a window in a shed which admits natural light may nevertheless be inappropriate to its mode of use.

Thus if the shed is intended to store various goods and is not otherwise occupied, the shed window should then seal the window opening in the wall of the shed so as to exclude both air and rain. There is no need to ventilate the shed in this storage mode and it is best that the window be sealed and latched for purposes of security.

However, when the shed is to serve as a temporary shelter for individuals, then it must be ventilated. But if for ventilation purposes, the shed window can be opened, there is not only a loss of security but the open window admits as well as air.

Because sheds are usually required only for temporary use, and there is often an immediate need for the shed, this need cannot be satisfied if the shed has to be constructed at the site at which it is to be used. To satisfy a need for a shed that can be quickly erected, it is known to prefabricate a shed by constructing its wall sections in a factory and shipping the sections to a site where they can quickly be assembled.

As a practical matter, it is not feasible for a manufacturer of prefabricated sheds to include windows in the wall sections thereof, for the manufacturer does not know the use to be made of the shed by its ultimate user and therefore does not know the type of shed window that is appropriate to its use.

It is therefore now the practice for the manufacturer of prefabricated sheds to include in at least one wall section of this shed a port or window opening so that the purchaser can later install in the port a window that best suits his purpose.

### SUMMARY OF THE INVENTION

In view of the foregoing the main object of this invention is to provide a companion set of sealing and ventilation window modules, each module being installable in a port in the side of a shed to admit natural light. The choice of module depends on the shed's intended mode of use.

A significant feature of the invention is that the shed port in which either module is installable is provided with a jamb that sockets the module so as to pivot it at the lower leg of the jamb whereby the module can then be swung to a closed state at which it is latched to the upper leg of the jamb or swung open.

More particularly, an object of this invention is to provide companion plastic sealing and ventilation window modules which are injection molded to create a unitary window structure having a pane configuration that defines the operating characteristics of the module. Hence the main difference between the companion modules in the set resides in the structure and function of the panes.

Briefly stated, these objects are attained in a companion set of sealing and ventilation window modules which are injection molded from transparent plastic material. The modules are installable in a rectangular port at the side of a shed to admit natural light therein, the sealing module excluding air and rain, the ventilation module admitting air into the shed but excluding rain.

Each module includes a rectangular frame which fits neatly within the rectangular port. In the sealing module, held within the frame is a corrugated pane which defines an array of convex ribs that reinforce the module, the surface of the ribs being frosted to render the pane translucent so that one cannot look into the shed through the window to view its contents. In the ventilation module, held within the frame is a corrugated pane that defines an array of horizontal ledges, each having a row of air holes therein whereby this module admits air into the shed but not rain which falls at an angle to the ledges.

### BRIEF DESCRIPTION OF THE DRAWINGS

For a better understanding of the invention as well as other objects and features thereof, reference is made to the annexed drawings wherein:

FIG. 1 is a front view of a port formed in the side of a shed which is adapted to receive either a sealing or a ventilation window module in accordance with the invention;

FIG. 2 is a rear view of the port;

FIG. 3 illustrates in perspective the sealing module as seen from its front;

FIG. 4 is a rear view of the sealing module;

FIG. 5 illustrates the geometry of the corrugated pane of the ventilation module;

FIG. 6 is a perspective view of the ventilation module as seen when swung out to open the window;

FIG. 7 shows the ventilation module when closed;

FIG. 8 shows the geometry of one corrugation in the pane of the ventilation module; and

FIG. 9 is a side view of the ventilation module when swung out of the port.

### DETAILED DESCRIPTION OF THE INVENTION

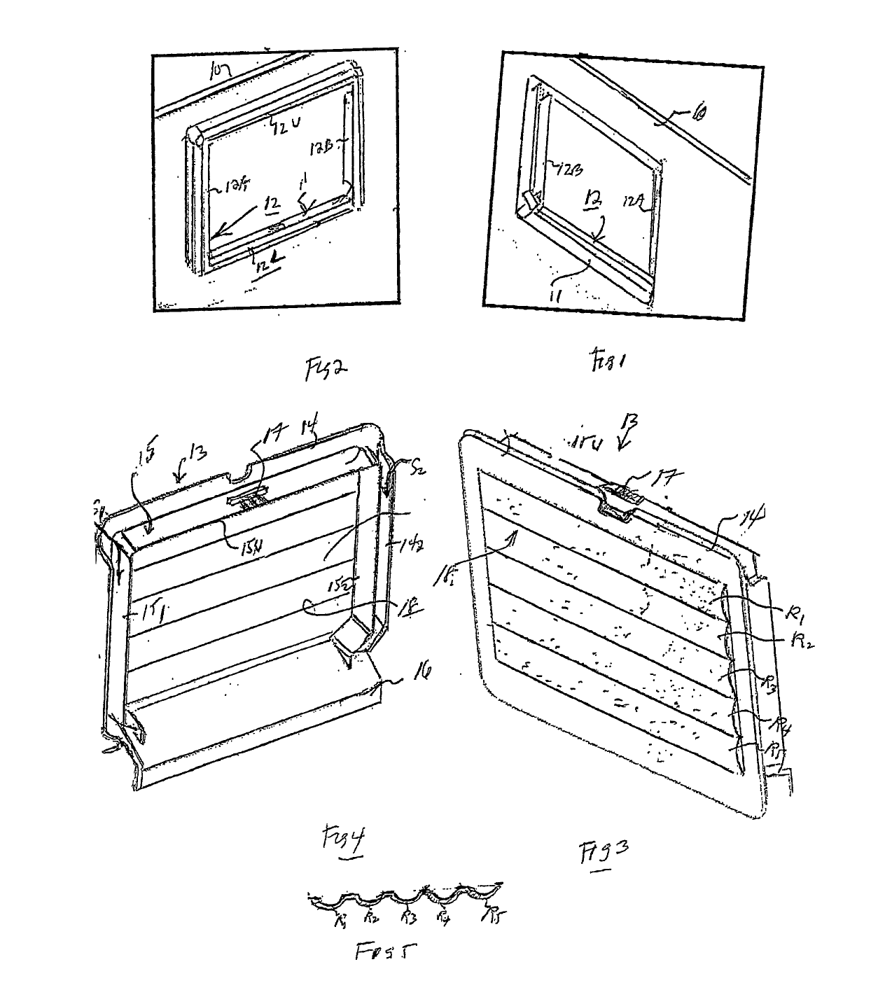

The Port: Referring now to FIGS. 1 and 2, shown in these figures in a side wall 10 of a shed or similar structure having a rectangular port 11 therein. The dimensions of this port are such as to accommodate a sealing or window module of a companion set. FIGS. 2, 3 and 4 show a sealing module in accordance with the invention and FIGS. 6 and 7 a ventilation module.

Attached to the rear of port 11 is a rear jamb 12 which serves to socket the module in the set selected to be used in conjunction with the port. This depends on the shed's mode of use; namely either in a storage mode in which goods are stored in the shed, or in a shelter mode in which the shed is occupied by one or more individuals.

Jamb 12 is formed by upper and lower legs 12L and 12U and left and right side legs 12A and 12B to create a rectangular socket for receiving whatever module is inserted in port 11. The lower leg 12L is adapted to function as a pivot for a hinge piece at the lower end of the module when received in the port so that the module can then be swung out at an angle to the wall to open the wall window. The upper leg 12U of jamb 12 is provided with latch means to engage a detent on the upper end of the module frame to lock the module when it is swung in to close the window.

The Sealing Module: As shown in FIGS. 3 and 4, a sealing module 13 in accordance with the invention is fabricated of transparent thermoplastic material of high strength such as PVC, polyethylene or polypropylene which is injection molded to create a unitary structure that fits into the shed port and is easily installed therein. No tools or particular skill is required for this purpose.

Module 13 includes a planar rectangular frame section 14 which nests within port 10 when the module is in its closed state. In this state the frame is then flush with the wall of the shed. Behind frame section 14 is a U-shaped projection to plug into the jamb socket in port. This projection includes a U-shaped strip 15 whose horizontal upper end 15E is parallel to the upper edge of frame 14 and whose vertical sides 15₁ and 15₂ are parallel to bent-in flanges 14₁ and 14₂ at the sides of frame 14. These flanges create channels S1 and S2 to receive the legs 12A and 12B of the port jamb.

Projecting rearwardly from the horizontal lower end of frame 14 of the module is a transverse hinge element 16 whose hook formation has an L-shaped cross-section whereby the hinge element can be hooked onto the lower legs 12L of port jamb 12 which then functions to pivot the module so that it is swingable in and out with respect to the port.

The horizontal upper end of 15U of strip 15 is provided at its center with a detent 17 which when the module is swung in to close the port, is then engaged by a latch (not shown) in the upper leg 12U of the jamb to lock the module so that it cannot be unlatched and opened.

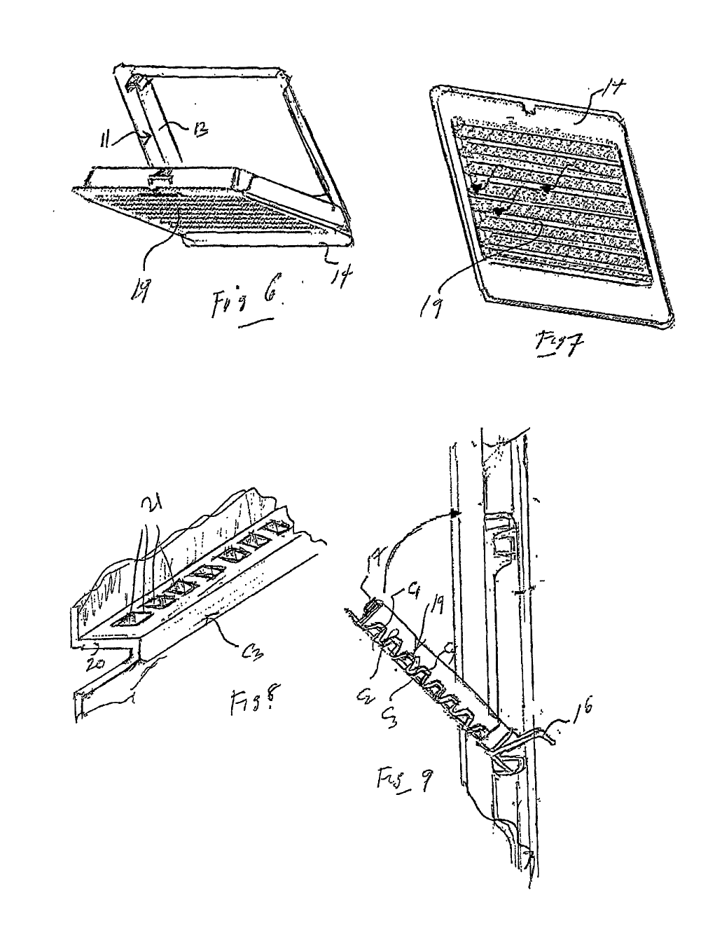

Held within frame 14 of the sealing module is a corrugated pane section 18 whose corruptions create an array of parallel ribs R1 to R5. These ribs, as best seen in FIG. 5, have a convex cross-section so that the ribs acts as reinforcing beams to resist bending forces that may be imposed on the module, such as blast forces from an explosion. The surface of the ribs is frosted to render the pane translucent so as to make it impossible to look into the shed. The sealing module which has no through holes therein or other openings excludes both air and rain, and only admits natural light.

The Ventilation Module: The injection-molded ventilation module shown in FIGS. 6 and 9 which is receivable in port 11 in the wall of the shed and socketed in its jamb is identical in all respects to the sealing module except for its pane 19 which differs from pane 18 of the sealing module in that it acts to make the module permeable to air but not to rain.

Pane 19 of the ventilation module which is injection molded of transparent plastic material is corrugated to form parallel corrugations C1, C2, C3 etc. which are so shaped as to create a parallel array of horizontal ledges 20. Each ledge, as best seen in FIG. 8, is provided with a row of equi-spaced air holes 21.

These air holes admit air into the shed through the ventilation module but no rain. Rain normally pours either straight down or at an angle to the horizontal plane and therefore will not enter the air holes inset in the horizontal ledges.

Conclusion: A manufacturer of prefabricated sheds having at least one wall section provided with a port 10, as shown in FIG. 1, can also supply the purchaser of the shed with a companion set of ventilation and sealing modules in accordance with the invention. In this way the user of the shed can install in the port the module he deems to be appropriate to its mode of use.

As an alternative to the illustrated module structures in which the modules when installed can be swung in and out with respect to the wall, one can provide a simpler design in which each module simply fits snugly into the port so that its flange is flush with the wall surface and cannot be swung. In this version of the module, the module may be provided with handles at either end of the frame by means of which one can press the module into the port to fit neatly therein or pull it out.

While there has been shown preferred embodiments of the invention, it is to be understood that many changes may be made therein without departing from the spirit of the invention.

The shed port illustrated in the drawings is small as are the window modules which fit into this port. But the invention encompasses ports of any size associated with modules having matching dimensions. Thus for a larger edifice such as a factory building in which the windows also serve as an emergency exit and therefore must be large enough for an individual to pass through, a window port must be large enough for this purpose, and the modules therefore must have like dimensions.

1. A companion set of sealing and ventilation modules installable in a rectangular port in a wall of a shed or a similar structure to admit natural light, the sealing module being installed when the shed is in a storage mode in which it acts to store goods, the ventilation module being installed when the shed is in a shelter mode to accommodate individuals, each module comprising:
A. a rectangular frame insertable into the port and
B. a corrugated pane held within the frame having corrugations which define an array of parallel elements whose geometry is such as to render the module suitable for the mode in which the shed is to be used.

2. A module as set forth in claim 1, formed of a thermoplastic transparent material that is injection molded to form a unitary structure.

3. A module as set forth in claim 1, in which the geometry of the elements in the array is such as to render the pane impermeable both to air and rain so that the module can be used when the shed operates in its storage mode.

4. A module as set forth in claim 3, in which the elements have a convex cross-section to form reinforcing beams.

5. A module as set forth in claim 4, in which the surface of the elements is frosted.

6. A module as set forth in claim 1, in which the elements define parallel horizontal ledges each having a row of air holes therein whereby the module admits air into the shed but not rain when the shed operates in a shelter mode.

7. A module as set forth in claim 1, in which the frame of the module is provided at its lower end with a hook-shaped hinge member that hooks onto a leg of a jamb secured to the port and functioning as a pivot so that the module can be swung in and out with respect to the port.

8. A module as set forth in claim 7, in which attached to the frame at an upper end thereof is a detent which when the module is swung to a closed position then engages a latch.

9. A sealing module injection molded of transparent thermoplastic material to create a unitary structure which is installable in a port in a wall of a shed for storing goods, said module comprising:
A. a frame that fits into the port; and
B. a pane held within the frame, said pane being corrugated to define a parallel array of reinforcing ribs having a convex cross-section.

10. A sealing module as set forth in claim 9, in which the surface of the ribs is frosted to render the module translucent.

11. A ventilation module installable in a port in a wall of a shed for sheltering individuals; said module comprising:
A. a frame that fits into the port, and
B. a pane held within the frame and corrugated to define a parallel array of horizontal ledges, each having a row of air holes to admit air into the shed but not rain.
